(19) United States
(12) Patent Application Publication
(10) Pub. No.: US 2013/0269793 A1
(43) Pub. Date: Oct. 17, 2013

(54) HOLDER DEVICE FOR SHOWER NOZZLE OR THE LIKE

(71) Applicant: Pi Kuang TSAI, Taichung (TW)

(72) Inventor: Pi Kuang TSAI, Taichung (TW)

(21) Appl. No.: 13/445,989

(22) Filed: Apr. 13, 2012

(51) Int. Cl. F16L 3/00

(52) U.S. Cl. 137/343

(57) ABSTRACT

A holder device for attaching to a supporting surface includes two attachment devices each having a housing, two suction members each having an outer peripheral portion engaged with the housing, and a shank attached to the suction member for moving the central portion of the suction member toward and away from a supporting surface, two carriers each has a cam member connected to the shank with a pivot shaft for selectively moving the shank and securing the housing to the supporting surface when the carrier is rotated relative to the housing to a working position where the carrier is in line with the shank, the shank and the suction member are released when the carrier is rotated relative to the housing to a folding position where the carrier is tilted relative to the shank.

### BACKGROUND OF THE INVENTION

1. Field of the Invention

The present invention relates to a holder device, and more particularly to a holder device for adjustably supporting shower nozzles or the like and for allowing the shower or sprayer nozzles to be easily and quickly and readily fetched or obtained by the users, particularly the children, and for readily attaching to the supporting the surfaces or walls or the like without drilling holes in the supporting surfaces or walls or the like.

2. Description of the Prior Art

Typical holder devices for supporting shower nozzles or other appliances comprise a bracket attached or secured to upper portions of supporting surfaces or walls or the like with fasteners. One or more holes should be drilled into the supporting surfaces or walls or the like with drilling machines or tools, for allowing the fasteners to be threaded into the supporting surfaces or walls or the like.

For example, U.S. Pat. No. 5,749,552 to Fan discloses one of the typical appliance holders including a wall mounted bracket which is required to be attached or secured to the supporting surfaces or walls or the like with fasteners or the like, and one or more holes should also be drilled into the supporting surfaces or walls or the like for threading the fasteners.

However, many families have no drilling machines or tools, and may not easily drilling the holes into the supporting surfaces or walls or the like by themselves, such that the typical appliance holders may not be easily attached or mounted to the supporting wall by the users themselves.

U.S. Pat. No. 6,446,278 to Lin discloses another typical appliance holder including a bracket attached or secured to the supporting surfaces or walls or the like with a stronger sucker member, without drilling holes into the supporting surfaces or walls.

However, similarly, after long term of using, the suction cups may also move or slide relative to the supporting surfaces or walls due to the weight of the appliances or the shower nozzles or the like, and due to the frequent attaching or disengaging of the shower nozzles to and from the bracket of the typical appliance holder.

U.S. Pat. No. 7,043,776 to Wu discloses a further typical appliance holder including a bracket attached or secured to the supporting surfaces or walls or the like with a suction cup or the like, without drilling holes into the supporting surfaces or walls. However, the bracket and the appliances or the shower nozzles or the like may not be solidly and stably attached or mounted or secured to the supporting surfaces or walls.

U.S. Pat. No. 7,197,976 to Tsai discloses a still further typical appliance holder including a bracket attached or secured to the supporting surfaces or walls or the like with a suction cup or the like, without drilling holes into the supporting surfaces or walls.

However, the bracket and the appliances or the shower nozzles or the like may not be solidly and stably attached or mounted or secured to the supporting surfaces or walls and may be easily disengaged from the supporting surfaces or walls due to the weight of the appliances or the shower nozzles or the like.

U.S. Pat. No. 7,299,510 to Tsai discloses a still further typical appliance holder attached or secured to the supporting surfaces or walls or the like without drilling holes into the supporting surfaces or walls.

However, the shower or sprayer nozzle is highly supported on the upper portion of the supporting surfaces or walls such that the users, particularly the children may not easily and quickly and readily fetch or obtain the shower or sprayer nozzle.

The present invention has arisen to mitigate and/or obviate the afore-described disadvantages of the conventional holder devices for supporting shower nozzles or the like.

### SUMMARY OF THE INVENTION

The primary objective of the present invention is to provide a holder device for adjustably supporting shower or sprayer nozzles or the like and for allowing the shower or sprayer nozzles to be easily and quickly and readily fetched or obtained by the users, particularly the children.

The other objective of the present invention is to provide a holder device for readily attaching to the supporting surfaces or walls or the like without drilling holes in the supporting surfaces or walls or the like.

In accordance with one aspect of the invention, there is provided a holder device for attaching to a supporting surface, the holder device comprising a first attachment device and a second attachment device each including a housing having a chamber defined by an outer peripheral flange and a partition, and the housing including an orifice formed in the partition, two suction devices each including a suction member having an outer peripheral portion contacted and engaged with the outer peripheral flange of the housing, and the suction members each including a central portion, and a shank attached and coupled to the central portion of the suction member for selectively moving the central portion of the suction member toward and away from the supporting surface, the shank being slidably engaged through the orifice of the partition, a rod including a lower portion and an intermediate portion, a first carrier and a second carrier each including a cam member extended outwardly therefrom and pivotally connected to the respective shank with a pivot shaft for selectively moving the shank and the central portion of the suction member toward the partition of the housing and away from the supporting surface and for selectively sucking and securing the housing to the supporting surface when the carrier is rotated relative to the housing to a working position where the carrier is in line with the shank, the shank and the central portion of the suction member being released by the carrier when the carrier is rotated relative to the housing to a folding position where the carrier is tilted relative to the shank, the first carrier including a passage formed therein for slidably receiving and engaging with the rod, and the second carrier including a cavity formed therein for receiving and engaging with the lower end portion of the rod, and a supporting device slidably and adjustably attached to the rod for removeably supporting a shower nozzle.

The first and the second carriers each include a groove formed in the cam member for receiving and engaging with a free end portion of the shank and for pivotally coupling to the free end portion of the shank with the pivot shaft. The pivot shaft includes at least one projection extended therefrom for selectively engaging with the cam member and for preventing the pivot shaft from being disengaged from the cam member.

The suction members each include a compartment formed in the central portion of the suction member, and the shanks each include an enlarged head received and engaged in the compartment of the suction member for coupling the shank to the central portion of the suction member and for selectively moving the central portion of the suction member toward and away from the supporting surface.

The suction devices each include a spring biasing member engaged onto the shank and engaged between the head of the shank and the partition of the housing for biasing and moving the head of the shank and the central portion of the suction member away from the partition of the housing.

The partitions of the housings each include an opening formed therein for selectively receiving and engaging with the first and the second carriers when the first and the second carriers are pivoted or rotated relative to the housings to the folding position where the first and the second carriers are tilted relative to the shanks respectively.

The housings each include a casing extended outwardly from the partition and directed away from the chamber of the housing, and each include a notch formed therein, and a cover engaged into the notch of the housing and attached to the casing and the housing.

The casings each include at least one lock cavity formed therein, and the covers each include at least one catch extended therefrom for selectively engaging with the lock cavity of the casing and for attaching to the casing and for preventing the cover from being disengaged from the housing and the casing.

The housings each include a pair of fences each having a guide channel formed therein, and the cam members of the first and the second carriers are received or engaged between the fences of the housings respectively, and the pivot shafts are slidably received and engaged in the guide channels of the fences respectively for guiding the cam member of the carrier to slide and to move relative to the casing and the housing.

The rod includes a slot formed in the lower portion thereof and received and engaged in the cavity of the second carrier, and a cap attached to the second carrier and having a stud extended outwardly therefrom for engaging with the slot of the rod and for anchoring and securing and locking the rod to the second carrier.

The supporting device includes a seat having a bore formed therein, and having an aperture formed through the seat and communicative with the bore of the seat for slidably receiving the rod, a catch slidably received in the bore of the seat and having an opening formed therein for slidably receiving the rod, and a spring member engaged in the bore of the seat and engaged with the catch for biasing the catch to press the rod and for adjustably securing the rod to the seat. The seat includes a bracket extended therefrom and having an engaging hole formed therein for removeably supporting the shower nozzle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a holder device in accordance with the present invention for adjustably supporting shower or sprayer nozzles or the like;

FIG. 2 is a perspective view of the holder device for adjustably supporting shower or sprayer nozzles or the like;

FIG. 3 is a partial cross sectional view of the holder device, taken along lines 3-3 of FIG. 2; and

FIGS. 4, 5, 6, 7 are partial cross sectional views similar to FIG. 3, illustrating the operation or attachment of the holder device to the supporting surfaces or walls or the like.

### DETAILED DESCRIPTION OF THE PREFERRED EMBODIMENT

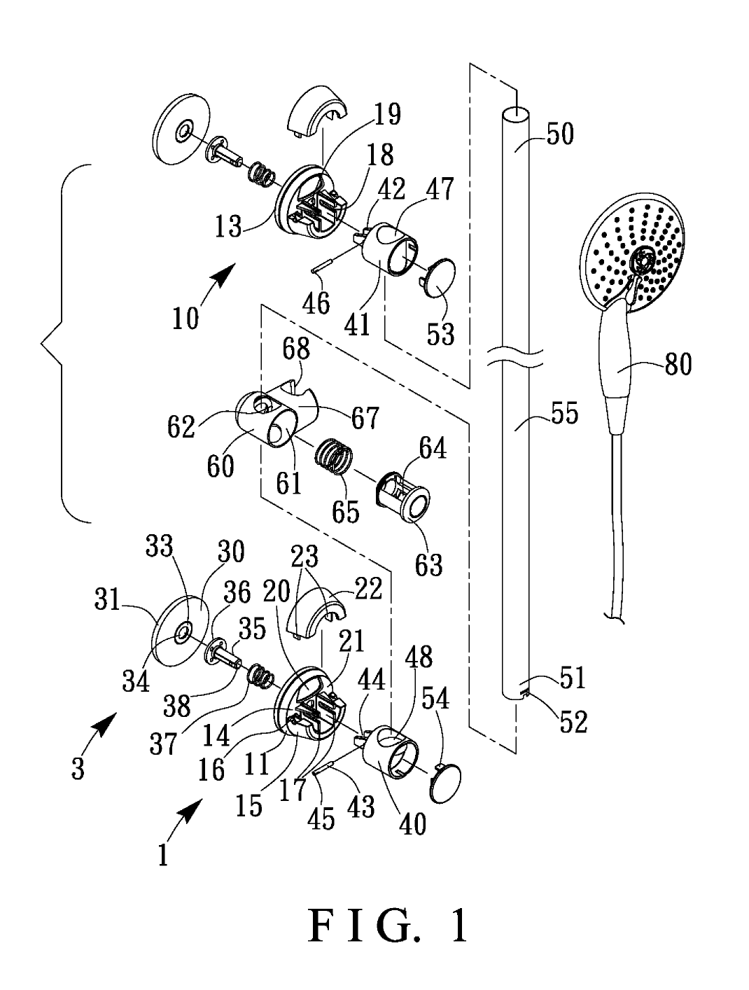

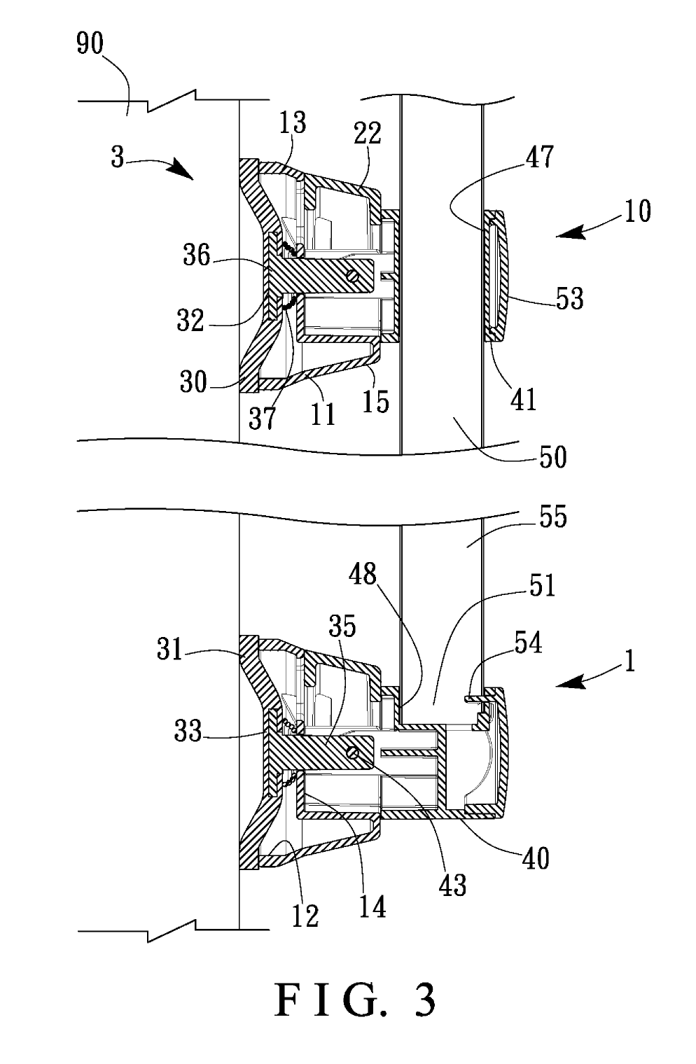

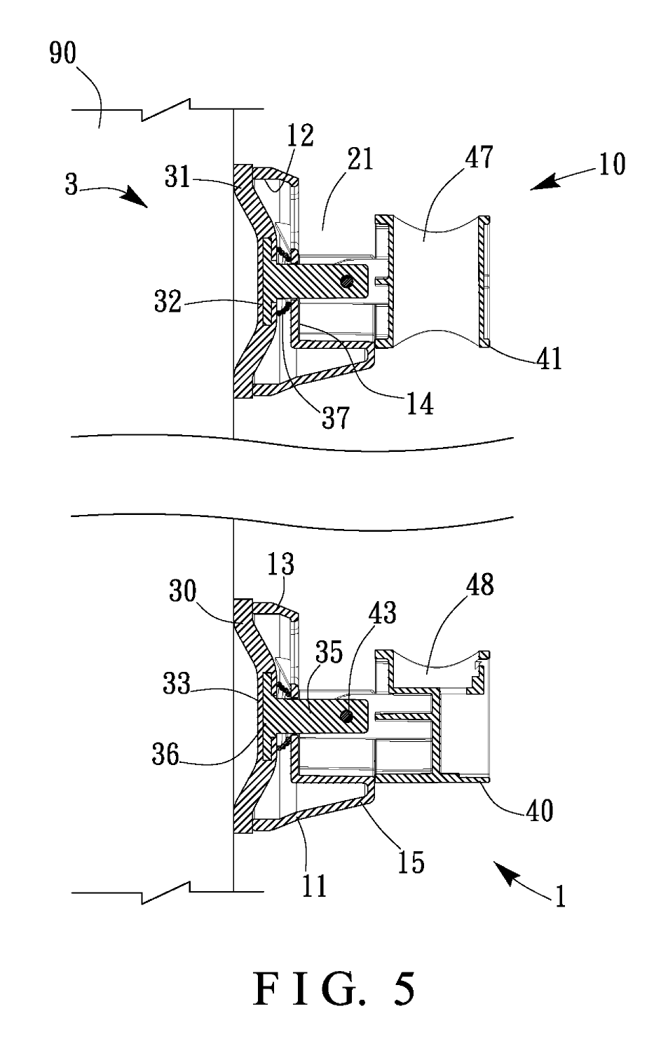

Referring to the drawings, and initially to FIGS. 1-3, a holder device in accordance with the present invention comprises a first or lower attachment device 1 and a second or upper attachment device 10 for attaching or mounting or securing to a supporting wall or surface 90 or the like, in which the attachment devices 1, 10 are almost identical in structure and each include a base or housing 11 for attaching or mounting or securing to the supporting surface 90 with a suction device 3. The housing 11 includes a chamber 12 formed therein (FIGS. 3-7) and formed or defined by an outer peripheral flange 13 and a partition 14, and includes a casing 15 extended outwardly from the partition 14 and faced or extended or directed away from the chamber 12 and the outer peripheral flange 13 of the housing 11, the casing 15 includes a substantially semi-cylindrical structure having a substantially semi-circular cross section.

As clearly shown in FIG. 1, the semi-cylindrical casing 15 includes one or more (such as two) lock cavities 16 formed therein, such as formed in the two opposite side portions thereof. The housing 11 further includes a pair of fences 17 extended within the casing 15 and parallel to each other and spaced apart for a predetermined distance, the fences 17 each include a guide channel 18 formed therein and faced or directed away from the partition 14. The housing 11 further includes an orifice 19 formed in the partition 14 and located between the fences 17, and in line with or aligned with the guide channels 18 of the fences 17, and further includes an opening 20 formed therein, such as formed in the upper portion of the partition 14 and communicative with the chamber 12 of the housing 11, and further includes a notch 21 formed therein and communicative with the opening 20 of the partition 14.

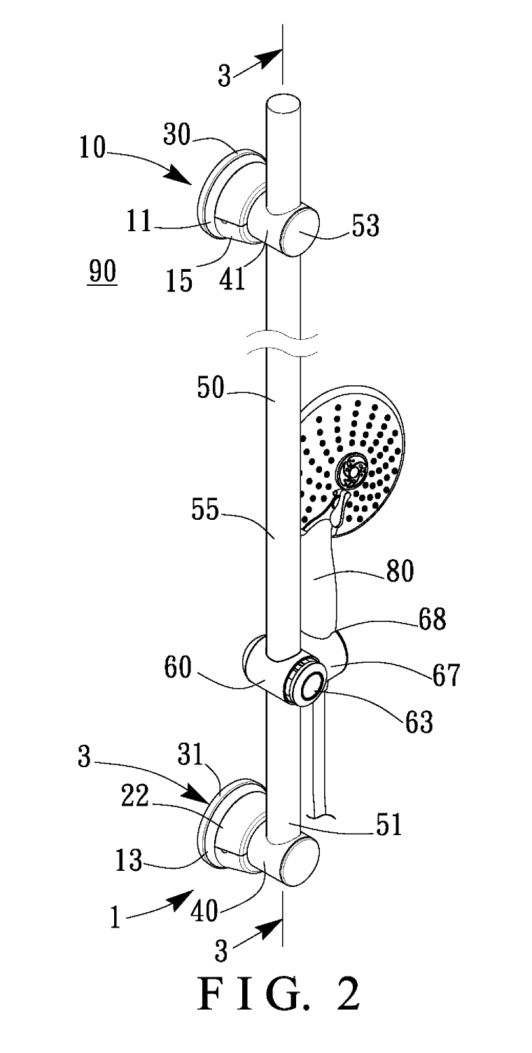

A cap or cover 22 is disposed or engaged into the notch 21 of the housing 11, and includes one or more (such as two) keys or projections or catches 23 (FIG. 1) extended therefrom for selectively engaging with the lock cavities 16 of the casing 15 and for attaching or mounting or securing to the casing 15 and the housing 11 and for preventing the cover 22 from being disengaged from the housing 11 and the casing 15. The partition 14 is thus located between the casing 15 or the notch 21 and the chamber 12 of the housing 11. The cover 22 also includes a substantially semi-cylindrical structure or frustum-shaped structure having a substantially semi-circular cross section, and may form a substantially cylindrical or wedge or frustum-shaped structure together with the casing 15, best shown in FIGS. 2-3 and 6-7. The fences 17 are thus extended and located within the casing 15 and the cover 21.

The suction device 3 includes a suction member 30 having an outer peripheral portion 31 to be contacted and engaged with and depressed or compressed by the outer peripheral flange 13 of the housing 11, best shown in FIGS. 2-7, and the suction member 30 includes a compartment 32 formed therein, such as formed in the central portion 33 thereof, and includes an aperture 34 formed therein, such as also formed in the central portion 33 thereof and intersecting or communicating with the compartment 32 thereof, in which the compartment 32 includes an inner diameter greater than that of the aperture 34 of the suction member 30. The suction device 3 further includes a stem or shank 35 slidably extended and engaged through the orifice 19 of the partition 14, and an enlarged head 36 provided and formed and extended at one end portion of the shank 35 and received or engaged in the compartment 32 of the suction member 30 for attaching or mounting or securing or coupling to the central portion 33 of the suction member 30, and for selectively pulling or moving the central portion 33 of the suction member 30 toward and away from the supporting surface 90.

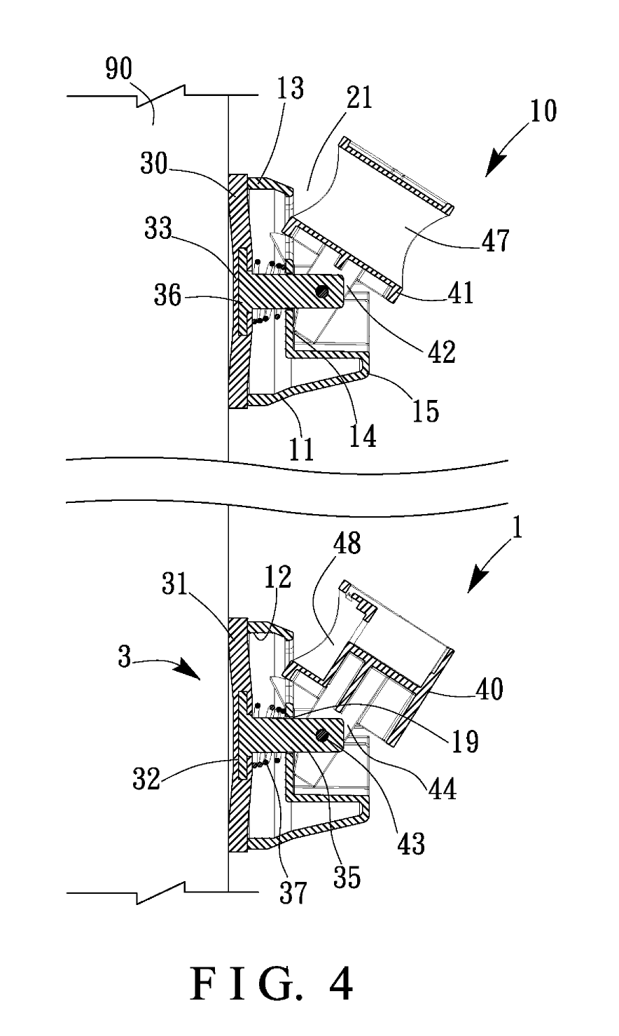

A spring biasing member 37, such as a coil biasing member 37 is provided and disposed or engaged onto the shank 35 and contacted and engaged with and disposed and located between the head 36 of the shank 35 and/or the central portion 34 of the suction member 30 and the partition 14 of the housing 11 for biasing or moving the head 36 of the shank 35 and/or the central portion 34 of the suction member 30 away from the partition 14 of the housing 11 (FIG. 4) when the shank 35 is released. The attachment devices 1, 10 each include a carrier 40, 41 having an extension or cam member 42 extended outwardly therefrom and engaged into the casing 15 and/or the cover 21, and pivotally or rotatably connected or coupled to the shank 35 with a pivot shaft 43 for selectively moving the shank 35 and the central portion 34 of the suction member 30 toward the partition 14 of the housing 11 and for selectively sucking and anchoring or securing or retaining the housing 11 to the supporting surface 90 with the suction force of the suction member 30 of the suction device 3.

The cam members 42 of the carriers 40, 41 are slidably received or engaged between the fences 17 of the respective housing 11 and each include a groove 44 formed therein (FIG. 1) for receiving or engaging with a free end portion 38 of the shank 35 and for pivotally or rotatably attaching or mounting or securing or coupling to the free end portion 38 of the shank 35 with the pivot shaft 43, in which the pivot shaft 43 has two end portions 45 extended out of the shank 35 and slidably received or engaged in the guide channels 18 of the fences 17 for guiding the cam member 42 of the carrier 40, 41 to slide and to move relative to the casing 15 and the housing 11 and also for allowing the cam member 42 of the carrier 40, 41 to be pivoted and rotated relative to the casing 15 and the housing 11. The pivot shafts 43 each may further include one or more keys or catches or nibs or projections 46 (FIG. 1) extended therefrom for selectively engaging with the cam member 42 and for preventing the pivot shaft 43 from being disengaged from the cam member 42.

The carrier 41, such as the upper carrier 41 includes a conduit or passage 47 formed therein for slidably receiving or engaging with a tube or rod 50, and the other carrier 40, such as the lower carrier 40 includes a recess or blind hole or cavity 48 formed therein for receiving or engaging with the lower end portion 51 of the rod 50 and for solidly and stably anchoring or securing or retaining the rod 50 between the carriers 40, 41, the rod 50 includes a slot 52 formed therein (FIG. 1), such as formed in the lower portion 51 thereof and received and engaged and located in the cavity 48 of the other or lower carrier 40. Two caps 53 each include one or more (such as two) catches or projections or studs 54 extended outwardly therefrom for engaging with the carriers 40, 41 respectively and for blocking or enclosing the carriers 40, 41, in which one of the studs 54 of the lower cap 53 may be engaged with or through the slot 52 of the rod 50 for anchoring or securing or locking the rod 50 to the lower carrier 40.

A supporting device 6 includes a seat 60 having a bore 61 formed therein, and an aperture 62 formed through the seat 60 and intersecting or communicative with and/or perpendicular to the bore 61 of the seat 60 for slidably receiving an intermediate portion 55 of the rod 50. A catch 63 is slidably received in the bore 61 of the seat 60 and includes an opening 64 formed therein for slidably receiving the intermediate portion 55 of the rod 50. A spring member 65 is also received or engaged in the bore 61 of the seat 60 and contacted and engaged with the catch 63 for biasing the catch 63 toward and to press the intermediate portion 55 of the rod 50 and for adjustably clamping or securing or coupling the intermediate portion 55 of the rod 50 to the seat 60. It is also preferable that the catch 63 includes a serrated surface or one or more teeth or projections formed therein (not shown), for frictionally engaging with the rod 50, and for solidly securing the rod 50 to the seat 60.

The seat 60 includes a bracket 67 attached thereto or extended therefrom and having a key hole or engaging hole 68 formed therein for removeably supporting the shower nozzle 80 (FIGS. 1, 2). It is to be noted that the seat 60 may be easily adjusted along the rod 50 to various or selected positions, in order to support the shower nozzle 80 at different or various or selected positions of the rod 50, to allow the shower nozzle 80 to be easily used by adults, children or various people of different sizes or heights, particularly the children and the elders. The shower nozzle 80 is typically coupled to water reservoirs for receiving water from the water reservoirs or the like. The seat 60 and the catch 63 and the bracket 67 and the shower nozzle 80 are typical and will not be described in further details.

In operation, as shown in FIGS. 2-7, the carriers 40, 41 are pivotal or rotatable relative to the housing 11 between a first or folding or inclined position (FIG. 4) where the carrier 40, 41 is tilted and inclined relative to the shank 35 and where the shank 35 is released by the cam member 42 and the carrier 40, 41, and a second or straight or working position (FIGS. 2-3, and 5-7) where the carrier 40, 41 is in line with the shank 35, and the suction members 30 may be disposed or attached or mounted or engaged onto the supporting surface 90 at any selected or required position when the carrier 40, 41 is tilted and inclined relative to the shank 35 and at the first or folding or inclined position, at this moment, the central portion 33 of the suction member 30 has not been moved away from the supporting surface 90 by the shank 35. The carrier 40, 41 may be tilted and received or engaged in the notch 21 and/or the opening 20 of the partition 14 of the housing 11 before the cover 22 is disposed or engaged into the notch 21 of the housing 11.

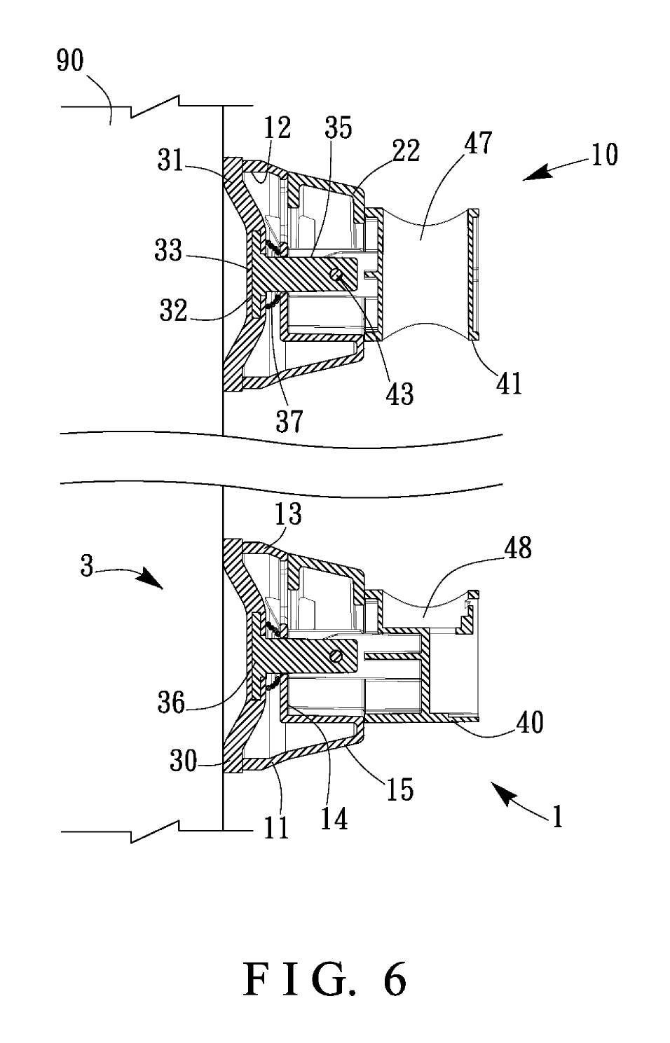

As shown in FIGS. 2-3, and 5-7, when the carrier 40, 41 is pivoted or rotated relative to the housing 11 to the second or straight or working position where the carrier 40, 41 is in line with the shank 35, the cam member 42 of the carrier 40, 41 may be engaged with the partition 14 and may pull and move the central portion 33 of the suction member 30 away from the supporting surface 90 in order to suck and attach or mount or secure the suction member 30 and the housing 11 and the carrier 40, 41 to the supporting surface 90. The cover 22 may then be disposed or engaged into the notch 21 of the housing 11 (FIG. 6) and may be anchored or secured or retained between the housing 11 and the carrier 40, 41 for anchoring or securing or retaining or locking the carrier 40, 41 to the housing 11 at the second or straight or working position, and for preventing the carrier 40, 41 from being pivoted and rotated relative to the casing 15 and the housing 11 to the first or folding or inclined position.

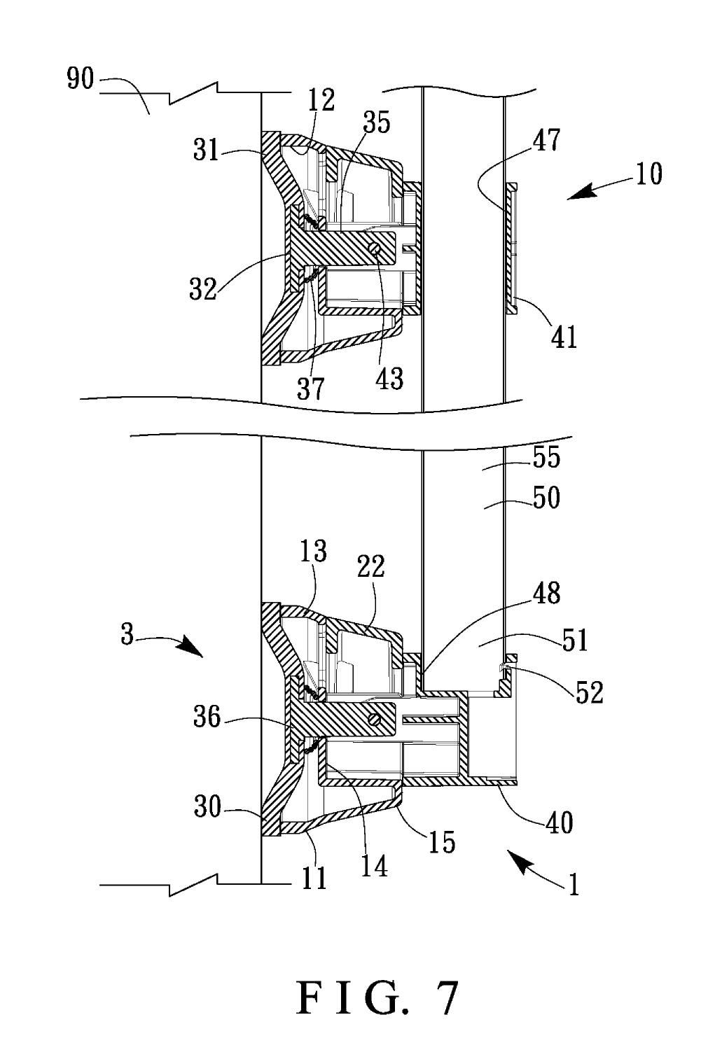

As shown in FIG. 7, the rod 50 may then be received or engaged into the passage 47 of the upper carrier 41, and the lower portion 51 of the rod 50 may then be disposed and received and engaged into the cavity 48 of the other or lower carrier 40 and may then be anchored or secured or retained or locked to the lower carrier 40 with the lower cap 53 when the stud 54 of the lower cap 53 is engaged with or through the slot 52 of the rod 50. The free end or outer end portions of the carriers 40, 41 may then be blocked or enclosed by the caps 53 (FIGS. 2-3). The seat 60 may be slidably attached or mounted or engaged onto the rod 50 before the lower portion 51 of the rod 50 is disposed and received and engaged into the cavity 48 of the other or lower carrier 40, and may be slidably and adjustably attached or mounted or engaged onto the rod 50 at any selected or predetermined positions such that the shower nozzle 80 may be supported at different or various or selected positions of the rod 50, to allow the shower nozzle 80 to be easily used by adults, children or various people of different sizes or heights, particularly the children and the elders. No holes are required to be drilled into the supporting surfaces 90 or walls or the like, such that the holder device may be easily assembled or mounted by the users themselves.

Accordingly, the holder device in accordance with the present invention may be used for adjustably supporting shower nozzles or the like, and for readily attaching to the supporting surfaces or walls or the like without drilling holes in the supporting surfaces or walls or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A holder device for attaching to a supporting surface, said holder device comprising:
a first attachment device and a second attachment device each including a housing having a chamber defined by an outer peripheral flange and a partition, and said housing including an orifice formed in said partition,
two suction devices each including a suction member having an outer peripheral portion contacted and engaged with said outer peripheral flange of said housing, and said suction members each including a central portion, and a shank attached and coupled to said central portion of said suction member for selectively moving said central portion of said suction member toward and away from the supporting surface, said shank being slidably engaged through said orifice of said partition,
a rod including a lower portion and an intermediate portion,
a first carrier and a second carrier each including a cam member extended outwardly therefrom and pivotally connected to said respective shank with a pivot shaft for selectively moving said shank and said central portion of said suction member toward said partition of said housing and away from the supporting surface and for selectively sucking and securing said housing to the supporting surface when said carrier is rotated relative to said housing to a working position where said carrier is in line with said shank, said shank and said central portion of said suction member being released by said carrier when said carrier is rotated relative to said housing to a folding position where said carrier is tilted relative to said shank, said first carrier including a passage formed therein for slidably receiving and engaging with said rod, and said second carrier including a cavity formed therein for receiving and engaging with said lower end portion of said rod, and
a supporting device slidably and adjustably attached to said rod for removeably supporting a shower nozzle.

2. The holder device as claimed in claim 1, wherein said first and said second carriers each include a groove formed in said cam member for receiving and engaging with a free end portion of said shank and for pivotally coupling to said free end portion of said shank with said pivot shaft.

3. The holder device as claimed in claim 1, wherein said pivot shaft includes at least one projection extended therefrom for selectively engaging with said cam member and for preventing said pivot shaft from being disengaged from said cam member.

4. The holder device as claimed in claim 1, wherein said suction members each include a compartment formed in said central portion of said suction member, and said shanks each include an enlarged head received and engaged in said compartment of said suction member for coupling said shank to said central portion of said suction member and for selectively moving said central portion of said suction member toward and away from the supporting surface.

5. The holder device as claimed in claim 1, wherein said suction devices each include a spring biasing member engaged onto said shank and engaged between said head of said shank and said partition of said housing for biasing and moving said head of said shank and said central portion of said suction member away from said partition of said housing.

6. The holder device as claimed in claim 1, wherein said partitions of said housings each include an opening formed therein for selectively receiving and engaging with said first and said second carriers when said first and said second carriers are rotated relative to said housings to said folding position where said first and said second carriers are tilted relative to said shanks respectively.

7. The holder device as claimed in claim 1, wherein said housings each include a casing extended outwardly from said partition and directed away from said chamber of said housing, and each include a notch formed therein, and a cover engaged into said notch of said housing and attached to said casing and said housing.

8. The holder device as claimed in claim 7, wherein said casings each include at least one lock cavity formed therein, and said covers each include at least one catch extended therefrom for selectively engaging with said at least one lock cavity of said casing and for attaching to said casing and for preventing said cover from being disengaged from said housing and said casing.

9. The holder device as claimed in claim 1, wherein said housings each include a pair of fences each having a guide channel formed therein, and said cam members of said first and said second carriers are received or engaged between said fences of said housings respectively, and said pivot shafts are slidably received and engaged in said guide channels of said fences respectively for guiding said cam member of said carrier to slide and to move relative to said casing and said housing.

10. The holder device as claimed in claim 1, wherein said rod includes a slot formed in said lower portion thereof and received and engaged in said cavity of said second carrier, and a cap attached to said second carrier and having a stud extended outwardly therefrom for engaging with said slot of said rod and for anchoring and securing and locking said rod to said second carrier.

11. The holder device as claimed in claim 1, wherein said supporting device includes a seat having a bore formed therein, and having an aperture formed through said seat and communicative with said bore of said seat for slidably receiving said rod, a catch slidably received in said bore of said seat and having an opening formed therein for slidably receiving said rod, and a spring member engaged in said bore of said seat and engaged with said catch for biasing said catch to press said rod and for adjustably securing said rod to said seat.

12. The holder device as claimed in claim 11, wherein said seat includes a bracket extended therefrom and having an engaging hole formed therein for removeably supporting said shower nozzle.
